(19) United States
(12) Patent Application Publication
(10) Pub. No.: US 2026/0168255 A1
(43) Pub. Date: Jun. 18, 2026

(54) Decorative Panel, Decorative Covering, and Method of Manufacturing Such a Decorative Panel

(71) Applicant: i4F Licensing NV, Turnhout (BE)

(72) Inventor: Eddy Alberic Boucké, Turnhout (BE)

(21) Appl. No.: 19/125,339

(22) PCT Filed: Oct. 31, 2023
(86) PCT No.: PCT/EP2023/080436

§ 371 Date: Apr. 29, 2025

(30) Foreign Application Priority Data
Oct. 31, 2022 (NL) 2033430

(51) Int. Cl. E04F 13/08; B32B 3/06; B32B 27/08; B32B 37/15; E04F 13/18

(52) U.S. Cl. CPC E04F 13/0871; B32B 3/06; B32B 27/08; B32B 37/153; E04F 13/0866; E04F 13/0894; E04F 13/18; B32B 2250/02; B32B 2255/10; B32B 2255/26; B32B 2307/4023; B32B 2307/4026; B32B 2307/554; B32B 2307/7265; B32B 2307/7376; B32B 2471/00; B32B 2607/02

(57) ABSTRACT

The invention relates to a decorative panel, in particular a decorative floor panel, including at least one core layer provided with an upper side and a lower side and a decorative top structure affixed, either directly or indirectly, to said upper side of the core. The invention also relates to decorative covering composed of a plurality of, preferably mutually coupled, decorative panels according to the invention. The invention further relates to a method of manufacturing a decorative panel according to the invention.

### CROSS-REFERENCE TO RELATED APPLICATIONS

This application is the United States national phase of International Patent Application No. PCT/EP2023/080436 filed Oct. 31, 2023, and claims priority to The Netherlands Patent Application No. 2033430 filed Oct. 31, 2022, the disclosures of which are hereby incorporated by reference in their entireties.

### BACKGROUND OF THE INVENTION

### Field of the Invention

The invention relates to a decorative panel, in particular a decorative floor panel, comprising at least one core layer provided with an upper side and a lower side and a decorative top structure affixed, either directly or indirectly, to said upper side of the core. The invention also relates to decorative covering composed of a plurality of, preferably mutually coupled, decorative panels according to the invention. The invention further relates to a method of manufacturing a decorative panel according to the invention.

### Description of Related Art

It has been common for centuries, to apply a surface covering of neighbouring tiles in a traditional way by applying a cement layer onto the surface, and subsequently position and fix the tiles onto the cement layer in a surface covering pattern. In this traditional method, grout is furthermore applied between adjacent side edges of neighbouring tile panels to fill up an interspatial gap between adjacent side edge, which filled gaps are commonly referred to as ‘grout lines’. These grout lines are visible as slightly recessed joint lines of grout which are present between adjacent top surfaces of neighbouring tiles.

As an alternative to the traditional way of applying a tile covering, it has been proposed in the art to develop a tile panel which has a top surface made from a synthetic material having similar properties as a traditional tile material such as ceramic material. When such tile panels are positioned adjacent to each other and adhered onto a surface, a covering of neighbouring tiles can be achieved in a different, and practical way in which no cement or grout is necessary. Typically, the adjacent side edges of these neighbouring tile panels are laid in abutting contact with each other, and may include interconnecting coupling profiles. In this way, one can dispense with the application of grout in the form of grout lines.

However, in order to mimic an overall appearance of a traditional tile covering, it has recently been proposed to provide the side edges of a tile panel with an imitation grout line by milling a rectangular groove in the top surface of the tile panel which recess extends along a side edge of the tile panel.

A drawback of the imitation grout line known from the above prior art, is that the imitation grout line is laborious and expensive to realize.

### SUMMARY OF THE INVENTION

It is a first object of the present invention to provide a panel with one or more imitation grout lines which can be realized in a relatively efficient manner.

It is a second object of the present invention to provide a panel with one or more imitation grout lines which can be realized in an alternative manner.

At least one of these objects can be achieved by providing a decorative panel suitable for covering a floor, ceiling or wall surface, which panel comprises:
at least one core layer,
at least one coloured layer, either directly or indirectly, affixed to an upper side of said core layer,
at least one decorative top structure, either directly or indirectly, affixed to an upper side of said coloured layer,
   wherein at least one core layer, preferably each core layer, and said coloured layer are co-extruded layers, and wherein the coloured layer comprises at least one exposed portion defining at least one imitation grout line. Here, at least one exposed portion is preferably situated along and/or at at least one side edge of the panel, which results in a peripheral imitation grout line (i.e. a grout line which is located at at least one side edge of the panel).

As indicated above, the decorative top structure is situated above the coloured layer, which normally results in the situation that the exposed portion(s) of the coloured layer is/are situated in a recessed portion of the upper side of the panel, which improves the look and feel of the imitation grout line.

It is imaginable and even preferable that at least one exposed portion of the coloured layer is left uncovered by the decorative top structure. This ensures a clear visibility of the exposed portion(s) of the coloured layer, as seen from a top of view of the panel. However, it is still imaginable that one or more exposed portions of the coloured layer are covered by at least one transparent and/or translucent protective layer. This protective layer will protect the exposed portion, in particular against wear, and will hence improve the durability of the panel. At least one of these one or more protective layers may be a coloured layer, wherein the colour may be identical or may deviate from the colour of the coloured layer positioned underneath said protective layer(s). This may improve the look and feel of the imitation grout line, and may even provide a visual depth effect to the imitation grout line. It is imaginable that at least one of these one or more protective layers is partially transparent and partially less transparent and/or opaque, which allows, for example, to mimic a grainy pattern which may improve the look and feel of the imitation grout line. It is even imaginable that one protective layer of the one or more protective layers is a transparent and/or translucent layer enriched with solid particles, such as grains, granules, flakes, dust, or powder, in order to further improve the visual appearance and/or the wear resistance of the imitation grout line. The one or more protective layers covering the at least one exposed portion of the coloured layer may merely covered the exposed portion(s) of the coloured layer. Alternatively, the one or more protective layers covering the at least one exposed portion of the coloured layer may cover the entire coloured layer and/or both the exposed portion(s) and at a least a part of a remaining part of the coloured layer. Typically, but not necessarily, the one or more protective layers are situated in between the coloured layer and the decorative top structure. It is also imaginable that one or more protective layers which cover at least one exposed portion of the coloured layer make part of the decorative top structure, in particular in case the decorative top structure comprises a plurality of layers.

By using co-extrusion as production technology to realize the laminate at least one core layer, preferably each core layer (in case the core would be composed of a plurality of core layers), and the coloured layer, the core layer(s) and the coloured layer are manufactured simultaneously by means of (co-)extrusion, typically in the direct vicinity of each other, and preferably above or on top of each other to align the layers already during the extrusion process. Hence, co-extrusion is the extrusion of multiple panel layers simultaneously. Preferably, at least one, more preferably each panel layer, and preferably at least one, more preferably each extruded panel layer, comprises at least one thermoplastic material, such as polypropylene (PP), polyurethane (PU), thermoplastic polyurethane (TPU), polystyrene (PS), polyethylene (PE), polyethylene terephthalate (PET), and/or polyvinyl chloride (PVC). At least one thermoplastic based layer, such as a core layer, may either be solid or foamed. Although the coloured layer may also be foamed, this coloured layer is in most embodiment a solid (unfoamed) layer, and more in particular a solid film. The polymer used in a panel layer, preferably an extruded panel layer, is preferably at least partially composed of a polymer formed by a mixture of virgin polymer material, recycled polymer material, or a combination of virgin and recycled polymer material. Preferably, at least one the polymer used in a panel layer, preferably an extruded panel layer, is preferably enriched with at least one additive, preferably at least one additive chosen from the group consisting of: talc, chalk, wood, calcium carbonate, titanium dioxide, calcined clay, porcelain, glass particles, glass fibres, carbon particles, silicon particular, a(nother) mineral filler, rice, textile fibers, such as cotton fibers, and another natural filler.

Co-extrusion preferably utilizes two or more extruders to melt and deliver a steady volumetric throughput of different viscous plastics to a single extrusion head (die) which will extrude the materials in layers, in particular sheets. The layer thicknesses may be controlled by the relative speeds and sizes of the individual extruders delivering the materials. By using co-extrusion, a laminate of the core layer(s) and the coloured layer, and optional one or more further (thermoplastic based) panel layers, can be manufactured in a relatively fast and cost-efficient manner. This co-extrusion process can be a continuous process. It is hence no longer needed to separately apply a strip of a grout imitating coating after manufacturing (and cooling down) of the panel core. Preferably, the coloured layer covers the entire upper surface of the (upper) core layer. The panel core can be composed of a single extruded layer, but may also be composed of a plurality of extruded core layers and/or of a plurality of core layers wherein at least one core layer is (co-)extruded and wherein other core layer is not (co-)extruded. The different core layers may have an identical composition, but may also have mutually different compositions. The plurality of core layers and the coloured layer may be (co-)extruded simultaneously.

Preferably, following the co-extrusion process, the extruded layers, which are still in softened state, are mutually adhered, preferably means of pressing, in particular hot pressing and/or calendaring by using at least one calender. Separate glue or another adhesive is typically not needed to adhere the simultaneously extruded layers. Hence, preferably said at least one opaque coloured layer is directly affixed to an upper side of said core layer (hence without intermediate adhesive layer).

A calender comprises a series of (hard) pressure rolls used to finish or smooth the extruded panels layer as well as to mutually compress and hence adhere the extruded layers. Calendaring is normally performed when the extruded layers are still and/or brought in softened state. One or more calender rolls of the calender may be heated or cooled, respectively. During the pressing process, in particular the calendaring process, one or more further panel layers may be embedded in the laminate of layers, such as one or more reinforcement layers and/or at least a part of the decorative top structure. One or more reinforcement layers may e.g. be embedded in between two core layers (if a plurality of core layers would be applied), and/or in between the coloured coating and the core. Examples of reinforcement layers are glass-fibre layers and/or textile layers, such as cotton layers. One or more adhered panel layers may be fused together without using a separate adhesive. To this end, it is preferred that the fused panel layer comprise the same or substantially the same thermoplastic polymer(s) to facilitate the fusion process. Alternative or additionally, one or more adhered panel layers may be glued together by using a separate adhesive (glue). As indicated above, it is imaginable that at least one core layer of a plurality of applied core layers of the panel according to the invention is not co-extruded together with other extruded panel layer, and may even not be extruded at all. This increases the freedom of design of the panel.

The coloured layer preferably has a tonality that approximates a black or grey colour or other background colours such as, but not limited to dark brown, light grey, or dark grey. This normally leads to a panel with a highly realistic looking and yet imitation grout line. Obviously, also other colours may be used for the coloured layer, preferably so as to offer a close match with and consistency of colour relative to the overall colour of the resulting panel. For example, it may be preferred that the colour of the decorative top structure, in particular at least one decor layer thereof, and the coloured layer may be based upon the same base colour, but with different tonalities of said base colour. Preferably, the coloured layer is darker than the decorative top structure. Preferably, the coloured layer has a different colour and/or different colour tone (tonality) than the colour of the decorative top structure. Preferably, the coloured layer has a different texture than the texture of the decorative top structure. Preferably, the at least one exposed portion of the coloured layer defining the at least one imitation grout line, may have a flat, and/or angular, and/or curved upper surface. The curved upper surface of the exposed portion(s) of the coloured layer may be a concavely curved upper surface (as seen in cross-sectional view). This concavely curved upper surface may further improve the look and feel of an actual grout. A deepest point of the concavely curved upper surface is preferably positioned at a distance from the longitudinal edges of the exposed portion, and hence in between said longitudinal edges. The concavely curved upper surface may have a symmetrical shape or a non-symmetrical shape.

Preferably, the coloured layer comprises at least one colorant or dye, preferably having a colour that may match or represents a grout colour. Preferably, the coloured layer comprises at least one thermoplastic material. Examples of suitable thermoplastic materials have been given above. The coloured layer is typically a thin, coloured, thermoplastic based film, which is applied, directly of indirectly, onto the core layer.

Preferably, the coloured layer is a wear-resistant layer. Optionally, the coloured layer is enriched with particles to improve the wear-resistance, such as aluminium oxide.

Preferably, the coloured layer comprises an anti-slip substance is composed of a material chosen from the group consisting of: carborundum, corundum, quartz, silica, glass particles, feldspar, clay, ceramic, carbon, textile, fused aluminium oxide, an auxiliary polymer deviating from the main (thermoplastic) polymer of the coloured layer, or combinations thereof. Examples of such an auxiliary polymer is polycarbonate, acetal, polyamide, and acrylic resins. Fused aluminium oxide offers more wear resistance than calcined aluminium oxide, and is therefore preferred over calcined aluminium oxide. In general, larger particle sizes typically increases the wear resistance. The anti-slip substance may lead to a textured upper surface of the exposed portion(s) of the coloured layer. The anti-slip substance may improve the look and feel of the imitation grout line, and moreover provides the imitation grout line with anti-slip properties. This latter will lead to more safe coverings composed of a plurality of panels according to the invention, in particular in humid environments, such as bathrooms, swimming pools, or outdoor, with a reduced risk of injuries and accidents.

Preferably, the at least one exposed portion of the coloured layer, and preferably the entire coloured layer is textured and/or has a textured upper surface. This texture could at least partially be defined by enriching the coloured layer with at least one anti-slip substance (as indicated above). Alternatively or additionally, this texture could be realized e.g. during extrusion and/or by mechanically pressing and/or milling and/or by etching, such as chemical etching. It is, for example, that the co-extruded layers are laminated in a calender after which the exposed portion(s) of the coloured layer are subjected to a post-treatment, for example a milling and/or etching treatment, wherein at least a part of the texture is realized.

Preferably, the coloured layer is a water impermeable layer shielding the core layer(s) from moisture. By allowing the coloured layer to act as water barrier, affection of the core layer due to exposure to moisture can be prevented. This allows for example, to use one or more moisture-sensitive materials in the core layer(s) and/or any other layer positioned underneath said coloured layer. An example of such a moisture-sensitive material is wood. Here, for example, it is imaginable that at least one core layer comprises cork dust, bamboo dust, wood dust, wood fibers, or other cellulose based material. These cellulose materials may, for example, be added as additive to at least one extruded core layer. It is also imaginable that at least one core layer is a non-extruded core layer which may consist of and/or comprise wood, and which may, for example, be formed by wood particle board, a chipboard, a medium density fibreboard (MDF), and/or a high density fibreboard (HDF). These boards are often moisture-sensitive (to some extent), but may be used in the panel according to the invention, in particular in case the coloured layer acts as water barrier.

Preferably, the coloured layer is a an opaque layer. Such an opaque layer may prevent the core layer(s) to remain visible, which provides more freedom of choice of colour of the core layer(s) applied. Typically, but not necessarily, the core layer(s) are not provided by dedicated colorants due to a typical lack of need to apply these colorants. Hence, the colour of the core layers is often determined by its composition of constituents. However, this does not take away the option to use one or more colorant in one or more core layer, respectively, for example to characterize the core layer. This characterization may for example relate to the one or more core layer properties, such as the thermoplastic material used in said core layer, the origin of one or more the material(s) used in the core layer and/or the recyclability of the core layer. In this manner, the coloured characterization of at least one core layer may act as informative signature representative for one or more properties of the core layer.

Preferably, the coloured layer comprises at least one polymer, such as polyvinylchloride (PVC) or polyurethane (PU), preferably thermoplastic polyurethane (TPU); and at least one colorant. As indicated above also other thermoplastic materials may be used. The colorant may be either homogeneously or non-homogenously dispersed within said polymer.

In a preferred embedment of the panel according to the invention, the a plurality of layers of the panel are based upon the same or substantially polymer, in particular thermoplastic polymer. This will facilitate post-use recycling. Preferably the core layer(s) and the coloured layer, and more preferably also at least one layer of the decorative top structure, comprise the same thermoplastic polymer, such as PVC, TPU, PP, PE, PET, etcetera.

Preferably, at least one intermediate layer is situated in between at least one core layer and said coloured layer. Preferably, at least one core layer, preferably each core layer, said intermediate layer, and said coloured layer are co-extruded layers. The intermediate layer may for instance be a reinforcement layer, sealing layer, primer layer, adhesive layer, and/or alternative functional layer. Preferably, the intermediate layer is thinner than the coloured layer. Preferably, the intermediate layer is thinner than at least one adjacent core layer.

It is imaginable and may even be preferred that at least one exposed portion of the coloured layer is covered by at least one transparent or translucent grout protection layer. The grout protection layer is preferably formed by a polymer comprising layer, in particular film. The polymer(s) used in the grout protection layer may be a thermoplastic plastic, such as PVC or TPU, and/or may be a thermoset polymer, such as a (cross-linked) epoxy resin.

Preferably, at least one core layer, preferably each core layer, an optional intermediate layer, said coloured layer and said grout protection layer are co-extruded layers. It is also imaginable that the grout protection layer is applied separately, optionally initially liquid form and cured afterwards.

Preferably, at least one exposed portion of the coloured layer connects to different, preferably opposing, panel edges while being situated at a distance from remaining panel edges. This leads to the embodiment that at least one imitation grout line intersects a centre portion of the panel, also referred to as intersecting imitation grout line. This leads to the virtual aesthetical effect that the panel is subdivided into a plurality of smaller panels. Such an intersecting imitation grout line can be realized by interrupting the decorative top structure. This latter can, for example, be realized applying a plurality of mutually distant decorative top structures on top of the coloured layer, typically in a side-by-side orientation. It is (also) imaginable that a single decorative top structure is initially applied on top of the coloured layer, wherein after completion of the decorative top structure at least one imitation grout line is created during a separate process step, for example by milling. In this latter option, the decorative top structure is position-selectively removed, preferably while leaving the coloured layer substantially in tact, thereby revealing at least one intersecting imitation grout line.

At least one, and preferably each imitation grout line, may have, and preferably has, one or more linear boundaries. However, it is also imaginable that at least one boundary of at least one imitation grout line is not entirely linear, but at least partially non-linear, such as regularly and/or randomly curved

Preferably, at least one exposed portion of the coloured layer has a varying layer thickness in a width direction. Here, it is for example imaginable that an edge side of at least one exposed portion is thinner compared to a decorative top structure side of said exposed portion, or vice versa. Alternatively, it is for example imaginable that a centre portion of at least one exposed portion is thinner compared to side edges (connecting to the panel side edge, and to the decorative top structure, respectively) of said exposed portion. In these manners, a bevel or chamfer can be created, which may be attractive from an aesthetical point of view and/or from a water drained point of view to urge water in a predefined direction, for example away from a seam formed in between two adjacent panels. It may be preferred that at least one exposed portion of the coloured layer has a varying layer thickness in a length direction. This will often lead to an inclined upper surface of the exposed portion in length direction, which will urge water towards a predefined terminal portion of the exposed portion. This may also improve the water drainage properties of the panel.

In a preferred embodiment, at least one portion of at least one core layer, preferably a portion located underneath at least one exposed portion of the coloured layer, has a varying layer thickness in a width direction. Such a portion of reduced thickness may for example be formed by means of extrusion, and/or milling, and/or (com)pressing. In this manner, at least one an imitation grout line positioned above said portion of reduced thickness may define, form, and/or comprise a bevel or chamfer. An inclined upper surface of said bevel or chamfer may be flat, angular, or curved.

Preferably, the surface area of the decorative top structure, as seen from as top view of the panel, is smaller than the total surface area of the coloured layer. Preferably, this smaller size is already applied during application of the decorative top structure, which prevents that one or more parts of the decorative top structure have to be removed in order to create the exposed portion(s) of the coloured layer.

Preferably, the decorative top structure comprises at least one decor layer (decorative layer) and at least one protective layer applied on top of said decor layer, wherein the at least one protective layer preferably comprises a texture.

The decorative layer may solely be formed by an ink layer representing a decor. The decorative layer may also comprises an ink carrying layer, such as a paper or polymeric film, carrying an ink layer representing the decor. Alternatively, it is imaginable that the decorative layer is a coloured layer, such as a polymer layer enriched with one or more colorants. The colour of the decorative layer may be a solid colour or may be composed of a plurality of colours. Typically, the decor defines a motif, an image, and/or a pattern, preferably composed of various colours. The decor is preferably printed, more preferably digitally printed, with (coloured) ink onto another panel layer, such as an ink carrying layer, in particular a film, typically composed of paper and/or thermoplastic material. The decor contributes to the visual appearance (the “looks”) of the decorative panel. One or more protective layers applied on top of the decor layer in order to protect the decor layer may have a textured upper surface or relief structure. Said textured upper surface or relief structure, also referred to as embossing structure, preferably matches the visuals of the décor at least partially, preferably entirely. This alignment is also referred as an alignment in register. This is for example attractive for imitated wood pattern, wherein the relief structure may comprise a plurality of impressions or cavities and/or grooves created by printing the relief structure, which are in register with the wood nerves and wood pores of the printed wood pattern. The location and depth of the impressions, cavities, and/or grooves, being a function of the wood nerves and wood pores of the printed pattern. The relief structure gives an improved and more realistic look-and-feel effect to the eventual decorative panels.

At least one protective layer may be a cured layer, such as an UV cured lacquer layer, which is preferably situated as uppermost layer. At least one other protective layer, preferably located underneath said cured layer (if applied) is configured to act as wear layer, and may be enriched with wear-resistant particles, such as aluminium oxide.

The decorative top structure preferably comprises at least one primer layer, at least one a décor layer on top of said primer layer, and at least one protective layer are applied on top of said decor layer. Preferably, said primer layer has white or whitish colour which will be in favour of the colour appearance (colour authenticity) of the printed décor applied, preferably directly, on top of said primer layer.

Preferably, the decorative top structure is thicker than the coloured layer located underneath said decorative top structure. The coloured layer has a thickness which is preferably situated between 0.03 and 0.2 mm. The decorative top structure preferably has a thickness between 0.2 and 1.2 mm, more preferably between 0.3 and 0.8 mm. Optionally, the panel comprises at least one backing layer. The backing layer may be a polymer, in particular thermoplastic, based layer and/or a cork layer. Preferably, said backing layer, at least one core layer, preferably each core layer, and said coloured layer are co-extruded layers. The thickness of the back layer is preferably between 1 and 2.5 mm, more preferably between 1.5 and 2.0 mm. Preferably, the thickness of the core is situated in between 2.3 and 14.8 mm. Preferably, the thickness of the core is at least two times, preferably at least three times, more preferably at least four times, and even more preferably at least five times the thickness of the decorative top structure. Preferably, the thickness of the core is at least ten times, preferably at least twelve times, more preferably at least fifteen times, and even more preferably at least twenty times the thickness of the coloured layer. The panel thickness may vary but is preferably situated in between 3.5 and 15 mm. The panel may be flexible, but is preferably rigid or semi-rigid. Preferably, the panel is sufficiently stiff that it cannot be rolled up. The panel is therefore preferably shape-retaining.

Preferably, the panel comprises a first panel edge comprising a first coupling profile, and a second panel edge, preferably opposing said first panel edge, comprising a second coupling profile being designed to engage interlockingly with said first coupling profile of an adjacent panel, preferably both in horizontal direction and in vertical direction. Preferably, this locking is such that a relatively tight seam is created in between the panels. This tight seam preferably prevents or impedes penetration of water in between said interconnected panels. This prevents or impedes that the core layer(s) and/or a subfloor (underlying the panel) is/are wettened and possibly affected upon moistening.

Preferably, the first coupling profile and the second coupling profile are configured such that two of such panels can be coupled to each other by means of a turning movement and/or by means of a vertical movement.

It is often preferred that the panel comprises at least one third coupling profile and at least one fourth coupling profile located respectively at a third panel edge and a fourth panel edge. Preferably, the third coupling profile and the fourth coupling profile are configured such that two of such panels can be coupled to each other by means of a turning movement.

In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank.

Preferably, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces.

In the abovementioned embodiment, it is imaginable that the first coupling profile (and/or third coupling profile) and the second coupling profile (and/or fourth coupling profile) are configured such that in coupled condition a pretension is existing, which forces coupled panels at the respective edges towards each other, wherein this preferably is performed by applying overlapping contours of the first coupling profile (and/or third coupling profile) and the second coupling profile (and/or fourth coupling profile), in particular overlapping contours of downward tongue and the upward groove and/or overlapping contours of the upward tongue and the downward groove, and wherein the first coupling profile (and/or third coupling profile) and the second coupling profile (and/or fourth coupling profile) are configured such that the two of such panels can be coupled to each other by means of a fold-down movement and/or a vertical movement, such that, in coupled condition, wherein, in coupled condition, at least a part of the downward tongue of the second coupling profile (and/or fourth coupling profile) is inserted in the upward groove of the first coupling profile (and/or third coupling profile), such that the downward tongue is clamped by the first coupling profile (and/or third coupling profile) and/or the upward tongue is clamped by the second coupling profile (and/or fourth coupling profile).

It is imaginable that the first coupling profile is configured to co-act with the second coupling profile as well as with the fourth coupling profile, and that the third coupling profile is also configured to co-act with the second coupling profile as well as with the fourth coupling profile. It is imaginable that the first coupling profile and the fourth coupling profile are identical.

In an embodiment of the panel according to the invention, the first coupling profile and/or the third coupling profile comprises: a sideward tongue extending in a direction substantially parallel to the upper side of the core, at least one second downward flank lying at a distance from the sideward tongue, and a second downward groove formed between the sideward tongue and the second downward flank, and wherein the second coupling profile and/or the fourth coupling profile comprises: a third groove configured for accommodating at least a part of the sideward tongue of the third coupling profile of an adjacent panel, said third groove being defined by an upper lip and a lower lip, wherein said lower lip is provided with an upward locking element, wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

It is conceivable that each first coupling profile and each third coupling profile is compatible—hence may co-act and interlock—with each second coupling profile and each fourth coupling profile. This may also apply in case interlocking coupling profiles do not have a completely complementary shape.

In a preferred embodiment, at least a coupling profile, and preferably all coupling profiles, is/are at least partially formed by the core.

The panel according to the invention is typically rectangular and may be square or oblong. Alternative shapes, like a triangular shape, a pentagonal shape, a hexagonal shape, or a parallelogrammatic shape, may also be applied as shape for the panel according to the invention.

The invention also relates to a decorative covering composed of a plurality of, preferably interconnected, decorative panels according to the invention.

The invention further relates to a method for producing a decorative panel according to the invention, comprising the steps of:
a) coextruding at least one core layer and at least one coloured layer,
b) mutually adhering said core layer and said coloured layer, preferably by means of hot pressing and/or calendaring,
c) affixing, either directly or indirectly, at least a part of a decorative top structure to an upper side of the coloured layer, such that the coloured layer comprises at least one exposed portion along at least one side edge of the panel, wherein said at least one exposed portion defines an imitation grout line,
d) optionally, affixing, either directly or indirectly, a backing layer to a lower side of the coextruded layer, and
e) optionally, affixing, either directly or indirectly, a transparent layer on an upper side of the exposed portion of the coloured layer.

Preferably, the at least a part of the decorative top structure is manufactured by means of extrusion and is preferably co-extruded during step a) and adhered to the coloured layer during step b). In an optional step f), coupling profiles may be applied, for example by milling, at at least one pair of opposing edges of the panel. Optionally, in step g) the (base) panel manufactured during steps a)-c) and optionally steps d) and/or e), is cut into smaller panels. Step g), if applied, is preferably performed prior to step f).

Further embodiments of the invention are described in the non-limitative set of clauses presented below:

### CLAUSES

1. Decorative panel suitable for covering a floor, ceiling or wall surface, which panel comprises:
   at least one core layer,
   at least one coloured layer, either directly or indirectly, affixed to an upper side of said core layer,
   at least one decorative top structure, either directly or indirectly, affixed to an upper side of said coloured layer,
      wherein at least one core layer, preferably each core layer, and said coloured layer are co-extruded layers, and wherein the coloured layer comprises at least one exposed portion along and/or at at least one side edge of the panel, wherein said at least one exposed portion defines an imitation grout line.
2. Panel according to clause 1, wherein the at least one exposed portion of the coloured layer is left uncovered by the decorative top structure.
3. Panel according to any of the preceding clauses, wherein the coloured layer is a wear-resistant layer.
4. Panel according to any of the preceding clauses, wherein the at least one exposed portion of the coloured layer, and preferably the entire coloured layer is textured and/or has a textured upper surface.
5. Panel according to any of the preceding clauses, wherein the coloured layer is a water impermeable layer shielding the at least core layer from moisture.
6. Panel according to any of the preceding clauses, wherein the coloured layer is a an opaque layer.
7. Panel according to any of the preceding clauses, wherein the coloured layer is a dark coloured layer and/or a grey coloured layer.
8. Panel according to any of the preceding clauses, wherein the coloured layer comprises at least one polymer, such as polyvinylchloride (PVC) or polyurethane (PU), preferably thermoplastic polyurethane (TPU); and at least one colorant.
9. Panel according to clause 8, wherein the colorant is non-homogenously dispersed within said polymer.
10. Panel according to clause 8, wherein the colorant is homogenously dispersed within said polymer.
11. Panel according to any of the preceding clauses, wherein at least one intermediate layer is situated in between at least one core layer and said coloured layer, wherein said wherein at least one core layer, preferably each core layer, said intermediate layer, and said coloured layer are co-extruded layers.
12. Panel according to clause 11, wherein the intermediate layer is thinner than the coloured layer.
13. Panel according to any of the preceding clauses, wherein at least one exposed portion of the coloured layer is covered by at least one transparent or translucent grout protection layer.
14. Panel according to clause 13, wherein at least one core layer, preferably each core layer, an optional intermediate layer, said coloured layer and said grout protection layer are co-extruded layers.
15. Panel according to any of the preceding clauses, wherein at least one exposed portion of the coloured layer connects to opposing panel edges while being situated at a distance from remaining panel edges.
16. Panel according to any of the preceding clauses, wherein at least one exposed portion of the coloured layer has a varying layer thickness in a width direction.
17. Panel according to any of the preceding clauses, wherein at least one portion of at least one core layer, preferably a portion located underneath at least one exposed portion of the coloured layer, has a varying layer thickness in a width direction.
18. Panel according to any of the preceding clauses, wherein at least one an imitation grout line includes and/or defines a bevel.
19. Panel according to any of the preceding clauses, wherein the decorative top structure comprises at least one decor layer and at least one protective layer applied on top of said decor layer, wherein the at least one protective layer preferably comprises a texture.
20. Panel according to any of the preceding clauses, wherein the decorative top structure comprises at least one primer layer, at least one a decor layer on top of said primer layer, and at least one protective layer are applied on top of said decor layer.
21. Panel according to any of the preceding clauses, wherein the decorative top structure comprises at least one decor layer formed by and/or bearing at least one digitally printed decorative image.
22. Panel according to any of the preceding clauses, wherein the decorative top structure is thicker than the coloured layer located underneath said decorative top structure.
23. Panel according to any of the preceding clauses, wherein the decorative top structure comprises at least one decor layer and at least one protective layer applied on top of said décor layer.
24. Panel according to any of the preceding clauses, wherein the panel comprises at least one backing layer, wherein said backing layer, at least one core layer, preferably each core layer, and said coloured layer are co-extruded layers.
25. Panel according to any of the preceding clauses, wherein the co-extruded layers are co-extruded, calendered layers.
26. Panel according to any of the preceding clauses, wherein the colour of the coloured layer is different from the colour of the core layer.
27. Panel according to any of the preceding clauses, wherein the colour of the coloured layer is different from the colour of the decorative top structure.
28. Panel according to any of the preceding clauses, wherein at least one core layer comprises at least one polymer, wherein preferably at least one polymer is at least partially composed of a polymer formed by a mixture of virgin polymer material and recycled polymer material.
29. Panel according to clause 28, wherein at least one polymer is enriched with at least one additive, preferably at least one additive chosen from the group consisting of: talc, chalk, wood, calcium carbonate, titanium dioxide, calcined clay, porcelain, glass particles, glass fibres, carbon particles, silicon particular, a(nother) mineral filler, rice, and another natural filler.
30. Panel according to any of the preceding clauses, wherein the panel comprises a first panel edge comprising a first coupling profile, and a second panel edge, preferably opposing said first panel edge, comprising a second coupling profile being designed to engage interlockingly with said first coupling profile of an adjacent panel, preferably both in horizontal direction and in vertical direction.
31. Panel according to clause 30 wherein the first coupling profile comprises:
   a first upward tongue,
   at least one first upward flank lying at a distance from the upward tongue,
   a first upward groove formed in between the first upward tongue and the first upward flank wherein the first upward groove is adapted to receive at least a part of a second downward tongue of a second coupling profile of an adjacent panel, and
   preferably at least one first locking element, more preferably provided at a distant side of the first upward tongue facing away from the upward flank, and wherein the second coupling profile comprises:
   a second downward tongue,
   at least one second downward flank lying at a distance from the downward tongue,
   a second downward groove formed in between the downward tongue and the downward flank, wherein the downward groove is adapted to receive at least a part of an upward tongue of a first coupling profile of an adjacent panel, and
   preferably at least one second locking element adapted for co-action with a first locking element of an adjacent panel, said second locking element more preferably being provided at the downward flank.
32. Panel according to clause 30 or 31, wherein the first coupling profile and the second coupling profile are configured such that two of such panels can be coupled to each other by means of a turning movement and/or by means of a vertical movement.
33. Panel according to any of clauses 30-32, wherein, in coupled state of adjacent panels, the first coupling profile of the panel and the second coupling profile of an adjacent panel are configured such that two of such panels can be uncoupled to each other by means of a turning movement and/or by means of a vertical movement and/or by means of a horizontal movement.
34. Panel according to any of the previous clauses, wherein the panel comprises at least one third coupling profile and at least one fourth coupling profile located respectively at a third panel edge and a fourth panel edge, preferably opposing the third panel edge, wherein the third coupling profile comprises:
   a sideward tongue extending in a direction substantially parallel to a plane defined by the panel and/or to the upper side of the core,
   at least one third downward flank lying at a distance from the sideward tongue, and
   a third downward groove formed between the sideward tongue and the third downward flank,
      wherein the third coupling profile and the fourth coupling profile are configured such that two of such panels can be coupled to each other by means of a turning movement and/or by means of a vertical movement and/or by means of a horizontal movement.
35. Panel according to clause 34, wherein the fourth coupling profile comprises a fourth groove configured for accommodating at least a part of the sideward tongue of the third coupling profile of an adjacent panel, said fourth groove being defined by an upper lip and a lower lip, wherein said lower lip is provided with an upward locking element, wherein, in coupled condition: at least a part of the sideward tongue of a first panel is inserted into the fourth groove of an adjacent, second panel, and wherein at least a part of the upward locking element of said second panel is inserted into the third downward groove of said first panel, wherein said lower lip preferably extends with respect to the upper lip.
36. Panel according to clause 35, wherein a fourth locking is provided at a distant side of the upward locking element facing away from the fourth groove, wherein said fourth locking element is configured to co-act with a locking element of a complementary coupling profile, in particular a second locking element of a second coupling profile of another panel, in coupled condition of said panels.
37. Panel according to one of clauses 30-33 and one of clauses 34-36, wherein the first coupling profile and the fourth coupling profile are identical.
38. Panel according to any of the preceding clauses, wherein the panel is an oblong, rectangular panel.
39 Panel according to any of clause 1-37, wherein the panel is a parallelogrammatic panel.
40. Decorative covering, in particular a decorative floor covering, comprising a plurality of mutually coupled decorative panels according to any of clauses 1-39.
41. Method for producing a decorative panel according to any of clauses 1-39, comprising the steps of:
   a) coextruding at least one core layer and at least one coloured layer,
   b) mutually adhering said core layer and said coloured layer, preferably by means of hot pressing and/or calendaring,
   c) affixing, either directly or indirectly, at least a part of a decorative top structure to an upper side of the coloured layer, such that the coloured layer comprises at least one exposed portion along at least one side edge of the panel, wherein said at least one exposed portion defines an imitation grout line,
   d) optionally, affixing, either directly or indirectly, a backing layer to a lower side of the coextruded layer,
   e) optionally, affixing, either directly or indirectly, a transparent layer on an upper side of the exposed portion of the coloured layer
42. Method according to clause 41, wherein at least a part of the decorative top structure is manufactured by means of extrusion and is preferably co-extruded during step a) and adhered to the coloured layer during step b).

### BRIEF DESCRIPTION OF THE DRAWINGS

The terms Fig., Figs., Figure, and Figures are used interchangeably in the specification to refer to the corresponding figures in the drawings.

The invention will be further elucidated by several non-limitative embodiments according to the present invention, wherein:

FIG. 1 schematically shows a top view of a decorative panel according to the invention;

FIG. 2a schematically shows a cross-sectional view of the decorative panel of FIG. 1;

FIG. 2b schematically shows a cross-sectional view of two coupled decorative panels;

FIG. 3 schematically shows a top view of a plurality of mutually coupled decorative panels; and

FIG. 4 schematically shows a part of a device for manufacturing decorative panels according to the present invention.

### DESCRIPTION OF THE INVENTION

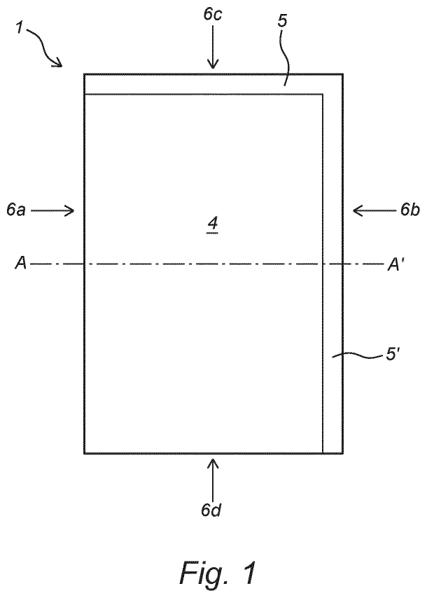

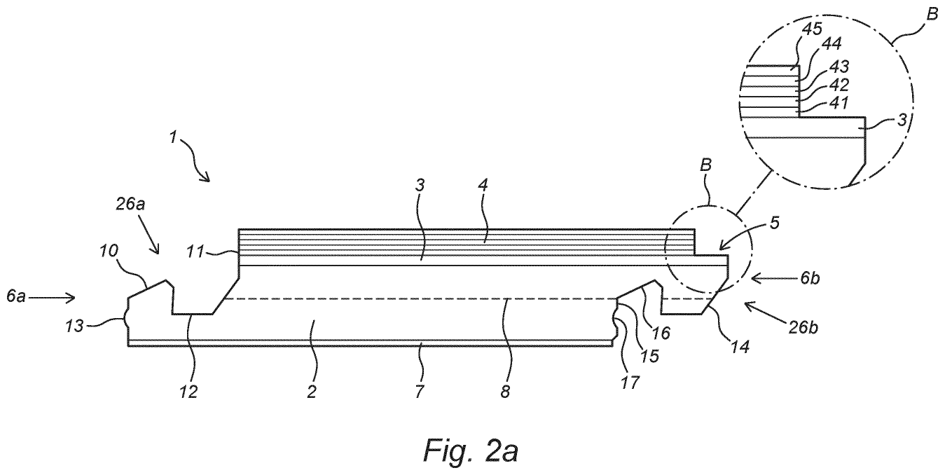

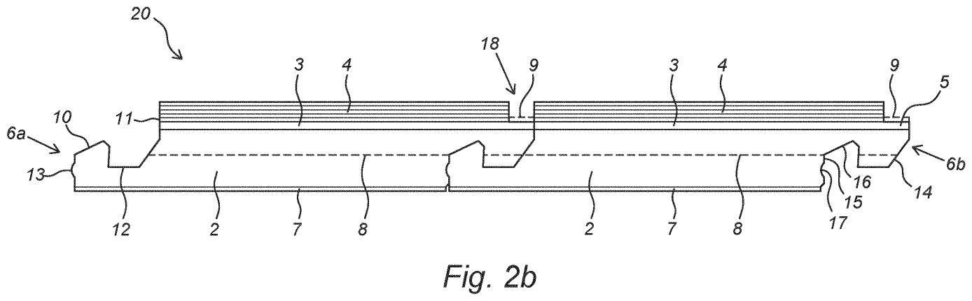

FIG. 1 shows a top view of a decorative panel 1 having a decorative top structure 4 and a plurality of side edges 6a-d. The panel 1 has an oblong rectangular shape, it is however also imaginable that the panel 1 has another shape such as a square, diamond, etc. The panel 1 of the shown embodiment is provided with two exposed portions 5 and 5′, along two side edges 6b and 6c of the panel 1. The panel can be provided with an exposed portion 5 on at least one side edge 6a-d of the panel 1. It is imaginable that at more than two side edge 6a-d of the panel 1 are provided with an exposed portion 5. Dotted line A-A′ indicates a cross-section of the panel 1 which is depicted in FIG. 2.

FIG. 2a shows a cross-section of the same panel 1 as in FIG. 1, along line A-A′ in FIG. 1. Identical parts in both figures have the same reference numerals as in FIG. 1. The panel 1 has a core layer 2 and on top of the core layer 2 a coloured layer 3. The panel 1 further has a decorative top structure 4 located on top of the coloured layer 3. The decorative top structure 4 at least partially covers the coloured layer 3 leaving an uncovered area defining the exposed portion 5 at one side edge 6b of the panel 1. It is imaginable that both side edges 6a, 6b comprise an exposed portion 5. The panel 1 further has a backing layer 7 on the lower side of the core layer 2. The core layer 2 and the coloured layer 3 have a different thickness. The exposed portion 5 of this embodiment is left uncovered by the decorative top structure 4. The core layer 2 of the shown panel 1 is provided with a reinforcement layer 8. It is imaginable that the core layer 2 comprises more than one reinforcement layer 8. The reinforcement layer 8 of the shown embodiment is embedded in the core layers 2. It is imaginable that the reinforcement layer 8 is embedded in between the coloured layer 3 and the core layer 2. It is also possible that the panel 1 comprises more than one reinforcement layer 8 embedded in the core layer and/or in between the coloured layer 3 and the core layer 2. The panel 1 is provided with coupling profiles 26a, 26b positioned on opposite longitudinal sides 6a, 6b respectively of the panel 1. A first coupling profile 26a comprises an upward tongue 10, an upward flank 11 and an upward groove 12 formed between the upward tongue 10 and upward flank 11. The side of the upward tongue 10 facing away from the upward flank 11 is provided with a first locking element 13. More specifically, the first locking element 13 is provided with an outward bulge. The second coupling profile 26b is substantially complementary to the first coupling profile 26a. The second coupling profile 26b comprises a downward tongue 14, a downward flank 15 and a downward groove 16 formed between the downward tongue 14 and downward flank 15. The downward flank 15 is provided with a second locking element 17. More specifically, the second locking element 17 is provided with a recess. The second locking element 17 is adapted for co-action with the first locking element 13 of an adjacent panel 1. In this embodiment, the second locking element 17 is adapted to receive the outward bulge of the upward tongue 10 of an adjacent panel 1. It is evenly possible that the first locking element 13 is provided with a recess and the second locking element 17 is provided with an outward bulge. The encircled portion B of the panel 1 is enlarged for the sake of clarity to further elucidate the decorative top structure comprising the layers 41, 42, 43, 44, 45 that are provided onto the upper side of the coloured layer 3. At least one carrier layer 41 is affixed, either directly or indirectly, onto the upper side of the coloured layer 3 leaving the exposed portion 5 uncovered. A primer layer 42 is provided onto said carrier layer 41, preferably the primer 42 is a white primer 42. A, preferably digitally printed, decor layer 43 is affixed, either directly or indirectly, on top of the primer layer 42. The decor layer 43 comprises a desired print of the decorative panel 1. To protect the carrier layer 41, the primer layer 42 and the decor layer 43 a wear layer 44 is provided over at least a part of the decor layer 43, preferably covering the entire decor layer 43. Although in this figure only one wear layer 44 is depicted, the skilled person would realise that a plurality of wear layers 44 may be provided. On top of the wear layer 44 a top coating layer 45 is provided that essentially entirely covers the wear layer 44, which top coating layer 45 may for example be a lacquer or a UV lacquer or like.

FIG. 2b shows a cross-sectional view of two coupled panels 20, wherein the two panels 20 are the same as the panel in FIG. 2a. Identical parts in both figures have the same reference numerals as in FIG. 2a. Both panels 20 have a core layer 2 and on top of the core layer 2 a coloured layer 3. The coloured layer 3 is at least partially covered by a transparent or translucent protection layer 9. The protection layer 9 covers at least the portion(s) lacking coverage of a decorative top structure 4. Preferably the protection layer 9 covers the entire coloured layer 3. The decorative top structure 4 at least partially covers the coloured layer 3 and/or protection layer 9 leaving at least one uncovered portion defining the exposed portion 5. The panel 1 further has a backing layer 7 on the lower side of the core layer 2. The core layer 2 of the shown panel 1 is provided with a reinforcement layer 8. The panel 1 is provided with coupling profiles 26a, 26b positioned on opposite longitudinal sides 6a, 6b respectively of the panel 1. A first coupling profile 26a comprises an upward tongue 10, an upward flank 11 and an upward groove 12 formed between the upward tongue 10 and upward flank 11. The side of the upward tongue 10 facing away from the upward flank 11 is provided with a first locking element 13 provided as an outward bulge. The second coupling profile 26b is substantially complementary to the first coupling profile 26a. The second coupling profile 26b comprises a downward tongue 14, a downward flank 15 and a downward groove 16 formed between the downward tongue 14 and downward flank 15. The downward flank 15 is provided with a second locking element 17 provided as a recess. The second locking element 17 is adapted for co-action with the first locking element 13 of an adjacent panel 1. In this embodiment, the second locking element 17 is adapted to receive the outward bulge of the upward tongue 10 of an adjacent panel 1. The two panels 20 can be coupled by means of a vertical movement. The coupling profiles 26a, 26b could also be designed to be coupled by means of a turning movement. The exposed portion 5 forms an imitation grout 18 when two panels 20 are coupled. The imitation grout 18 has another colour than the decorative top structure 4. It is imaginable that both side edges 6a, 6b comprise an exposed portion 5, forming in coupled state an in longitudinal direction of the panel 20 larger imitation grout 18 than shown.

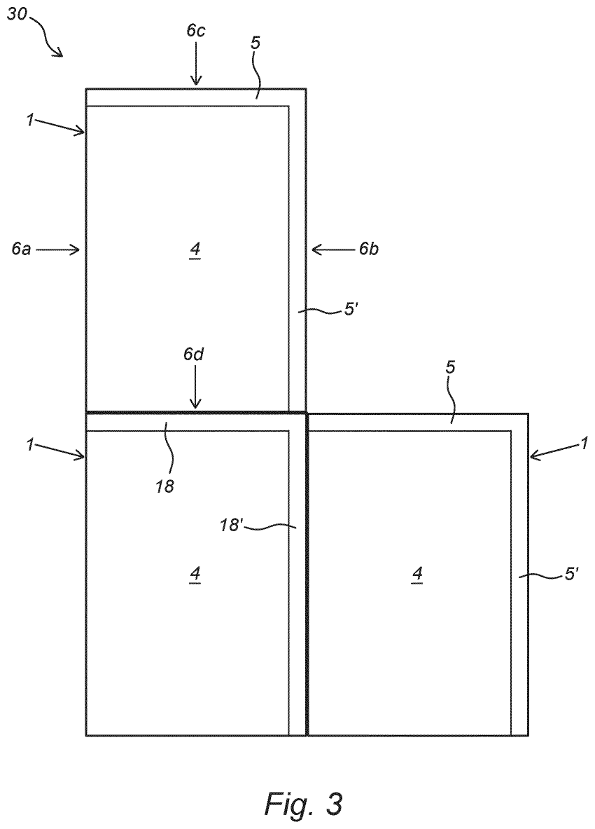

FIG. 3 shows a schematic top view of a decorative covering 30 comprising a plurality of mutually coupled decorative panels 1. The decorative panels 1 have a decorative top structure 4 and a four side edges 6a-d. The panels 1 are provided with two exposed portions 5 and 5′, along two side edges 6b and 6c of the panel 1. The exposed portions 5 and 5′ form two imitation grouts 18 and 18′ in between mutually coupled panels 1. The imitation grouts 18 and 18′ have another colour than the decorative top structure 4. It is imaginable that one or more side edges 6a-d comprise an exposed portion.

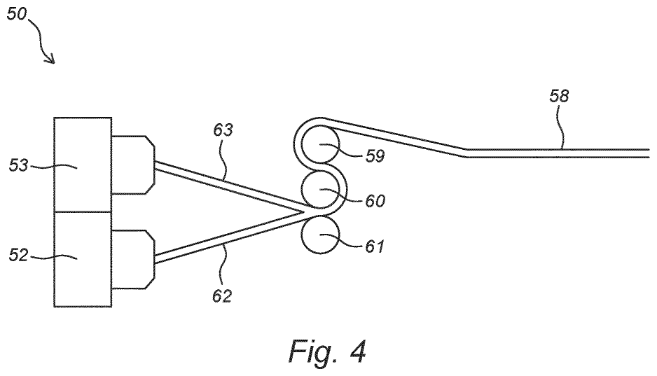

FIG. 4 schematically shows a schematic representation of at least a part of a decorative panel production device. The shown part of the production device comprises a co-extruder 50 for producing a basis panel. The co-extruder 50 comprises two extruders 52, 53 each providing one sublayer 62, 63 respectively to be co-extruded. The first extruder 52 discharges a first sublayer 62 comprising a slab of viscous or paste-like core material 62. The second extruder 53 discharges a second sublayer 63 comprising a slab of viscous or paste-like coloured material 63. The colour of the coloured material 63 differs from the colour of the core layer 62. The core layer 62 is in practice at least ten times the thickness of the coloured layer 63. Subsequently, the two sublayers 62, 63 are fed into three calendaring rolls 59, 60, 61. These calendaring rolls 59, 60, 61 mutually adhere the two sublayers 62, 63 together into a coextruded layer 58. Thereafter, a protection layer is optionally affixed on the upper side of the coextruded layer 58, more specifically on top of the coloured layer 63. A decorative top structure (not shown) is, directly or indirectly, affixed on top of at least a part of the coloured layer 23 of the coextruded layer 58, such that the coloured layer 63 comprises at least one exposed portion. It is imaginable that a backing layer (not shown) is affixed to the lower side, the core layer 62, of the coextruded layer 58. The coextruded layer 58 comprising the desired decorative top structure and optionally the backing layer together form a basic panel. This basic panel is subsequently divided into decorative panels comprising coupling profiles (not shown). In another embodiment it is possible that the co-extruder 50 comprises three extruders (not shown), wherein a third extruder discharges a third sublayer comprising a slab of backing layer material. The third extruder discharging backing layer material would be located at the lower side of the first extruder 52 producing the core material 62. The three sublayers could subsequently be fed into the calendaring rolls 59, 60, 61 and mutually adhered into a coextruded layer 58 comprising a backing layer. It is also possible that at least one calendaring roll 59, 60 and/or 61 is provided with a predetermined impressing structure, such as to form a predetermined bevel in the coextruded layer 58. The impressing structure can be pressed into the slab material 62, 63 such as to form a bevel.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application. Various embodiments of the panel as described above and in the appended claims may be combined with this alternative panel configuration.

By “horizontal” is meant a direction which extends parallel to a plane defined by the floor panel, and which may intersect the core. By “vertical” is meant a direction which is perpendicular to said plane defined by the floor panel. The ordinal numbers used in this document, like “first”, “second”, and “third” are used only for identification purposes. Hence, the use of the expressions “third locking element” and “second locking element” does therefore not necessarily require the co-presence of a “first locking element”.

By “complementary” coupling profiles is meant that these coupling profiles can cooperate with each other. However, to this end, the complementary coupling profiles do not necessarily have to have complementary forms. The “floor panel” according to the invention may also applied as wall covering element, ceiling covering element, or alternative covering element. In case in this document reference is made to a “floor tile” or “floor panel”, these expressions may be replaced by expressions like “tile”, “wall tile”, “ceiling tile”, “covering tile”.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1-42. (canceled)

43. A decorative panel suitable for covering a floor, ceiling or wall surface, which panel comprises:
at least one core layer,
at least one opaque coloured layer, either directly or indirectly, affixed to an upper side of said core layer,
at least one decorative top structure, either directly or indirectly, affixed to an upper side of said coloured layer,
wherein at least one core layer, and said coloured layer are co-extruded layers, and wherein the coloured layer comprises at least one exposed portion along and at least one side edge of the panel, wherein said at least one exposed portion defines an imitation grout line.

44. The panel according to claim 43, wherein the at least one exposed portion of the coloured layer is left uncovered by the decorative top structure.

45. The panel according to claim 43, wherein the coloured layer is a wear-resistant layer.

46. The panel according to claim 43, wherein the at least one exposed portion of the coloured layer is textured and/or has a textured upper surface.

47. The panel according to claim 43, wherein the coloured layer is a water impermeable layer shielding the at least core layer from moisture.

48. The panel according to claim 43, wherein the panel is rigid.

49. The panel according to claim 43, wherein the coloured layer is a dark coloured layer and/or a grey coloured layer.

50. The panel according to claim 43, wherein the coloured layer comprises at least one polymer, such as polyvinylchloride (PVC) or polyurethane (PU), thermoplastic polyurethane (TPU); and at least one colorant.

51. The panel according to claim 43, wherein at least one intermediate layer is situated in between at least one core layer and said coloured layer, wherein said wherein at least one core layer said intermediate layer, and said coloured layer are co-extruded layers, wherein the intermediate layer is thinner than the coloured layer.

52. The panel according to claim 43, wherein at least one exposed portion of the coloured layer is covered by at least one transparent or translucent grout protection layer.

53. The panel according to claim 43, wherein at least one exposed portion of the coloured layer has a varying layer thickness in a width direction.

54. The panel according to claim 43, wherein at least one portion of at least one core layer, located underneath at least one exposed portion of the coloured layer, has a varying layer thickness in a width direction.

55. The panel according to claim 43, wherein at least one an imitation grout line includes and/or defines a bevel.

56. The panel according to claim 43, wherein the decorative top structure comprises at least one primer layer, at least one a décor layer on top of said primer layer, and at least one protective layer is applied on top of said décor layer.

57. The panel according to claim 43, wherein the decorative top structure comprises at least one décor layer formed by and/or bearing at least one digitally printed decorative image.

58. The panel according to claim 43, wherein the decorative top structure is thicker than the coloured layer located underneath said decorative top structure.

59. The panel according to claim 43, wherein the colour of the coloured layer is different from the colour of the decorative top structure.

60. The panel according to claim 43, wherein the panel comprises a first panel edge comprising a first coupling profile, and a second panel edge, opposing said first panel edge, comprising a second coupling profile being designed to engage interlockingly with said first coupling profile of an adjacent panel, both in horizontal direction and in vertical direction.

61. A method for producing a decorative panel according to claim 43, comprising the steps of:
a) coextruding at least one core layer and at least one coloured layer,
b) mutually adhering said core layer and said coloured layer, by means of hot pressing and/or calendaring,
c) affixing, either directly or indirectly, at least a part of a decorative top structure to an upper side of the coloured layer, such that the coloured layer comprises at least one exposed portion along at least one side edge of the panel, wherein said at least one exposed portion defines an imitation grout line,
d) optionally, affixing, either directly or indirectly, a backing layer to a lower side of the coextruded layer,
e) optionally, affixing, either directly or indirectly, a transparent layer on an upper side of the exposed portion of the coloured layer

62. The method according to claim 61, wherein at least a part of the decorative top structure is manufactured by means of extrusion and is co-extruded during step a) and adhered to the coloured layer during step b).
